(19) United States
(12) Patent Application Publication
(10) Pub. No.: US 2002/0135740 A1
(43) Pub. Date: Sep. 26, 2002

(54) Projector housing with integral fan shroud

(76) Inventor: David G. Payne, Aloha, OR (US)

Correspondence Address: STOEL RIVES LLP, 900 SW FIFTH AVENUE, SUITE 2600, PORTLAND, OR, 97204, US

(21) Appl. No.: 09/815,071

(22) Filed: Mar. 22, 2001

(51) Int. Cl. G03B 21/18; G03B 21/26

(52) U.S. Cl. 353/57

(57) ABSTRACT

A fan assembly for an image projector includes a split fan shroud that substantially surrounds the fan but does not fully enclose it. The fan shroud has a height that is substantially equal to the height of the fan. In one embodiment the shroud includes opposed first and second sections that are separately mounted to the image projector. In another embodiment the shroud is integral with a portion of the image projector housing.

### TECHNICAL FIELD

This invention relates generally to a fan for multimedia image projectors and, more particularly, to a low profile fan assembly.

### BACKGROUND OF THE INVENTION

Image projection systems are becoming increasingly popular for conducting sales demonstrations, business meetings, and classroom instruction. Such image projection systems typically receive analog video signals from a personal computer (PC). The video signals may represent still, partial-, or full-motion display images of a type rendered by the PC. A projection engine of these projection systems includes a light source, an image-forming device, and optical components for directing images onto a screen. The light source typically includes a replaceable lamp module for generating and directing light toward the image-forming device before it is projected on the screen. In order to produce adequate light intensity, the lamp module includes a light source which may be, for example, a metal-halide or other type of arc lamp, an incandescent lamp, or a fluorescent lamp.

Such image projectors are becoming smaller, more compact, and lighter weight so that they can be carried by one person. The light source operates at high temperatures and must be cooled to prevent damage to the image projector. This is particularly important in smaller image projectors where the components are arranged in a compact manner. A cooling device typically includes a fan assembly having a fan housed within a shroud to help produce an effective air flow. The fan draws air into the projector housing and blows it over or across the light source and out of the housing through ventilation openings. The fan assembly is often the tallest component in an image projector. Therefore, the height of the projector housing is usually determined by the height of the fan assembly. The height of the projector housing becomes an important factor as image projectors become more compact. The height of current projector housings are greater than desired because of the presence of the fan shroud which typically completely surrounds the fan adding to its height.

An example of such prior art systems is seen in FIGS. 1 and 2 where an image projector 10 is shown which includes a housing 12 having a cavity 13 into which a lamp module 14 is slidably removed or inserted along a directional path generally indicated by an arrow 16. When fully inserted into the cavity 13, lamp module 14 is covered by an access panel (not shown) that snaps into place and is secured to housing 12 by a pair of cantilever snap latches 18. A cooling fan 36 is mounted within the housing 12 to direct airflow across arc lamp 39.

FIG. 2 shows a typical fan assembly 50 that includes a fan 52 having a shroud 54 that completely surrounds the fan 52 to provide an effective air flow. The shroud 54 extends above the fan blades 56 a distance allowing for clearance plus a distance at both the top and bottom of the fan 52 to have a total fan assembly height h. The fan assembly 50 fits within a projector housing cover 60 having a thickness t at both the top and bottom of the product. Thus, the overall height H of the projector housing is determined by the height h of the fan assembly 50.

It is therefore desirable to provide a low profile fan assembly that is sized to fit within a more compact housing and that produces sufficient air flow to ventilate heat produced by the image projector.

### SUMMARY OF THE INVENTION

It is an object of the invention to provide a low profile fan assembly for an image projector that provides a projector housing having a reduced height.

It is another object of the invention to provide a low profile fan assembly that can be easily installed in the projector housing.

A further object of the invention is to provide a low profile fan assembly that provides effective air flow.

A multimedia image projector includes a low profile fan assembly to provide a cooling air flow over or across a high temperature light source. The fan assembly includes a fan housed within and supported by a shroud that allows the projector housing to have a reduced overall height to be more compact and yet provides room for a fan having a size sufficient to produce the desired air flow.

In the preferred embodiment the fan assembly includes a split shroud having first and second sections located on opposite sides of the fan. Each section is connected to the projector housing to form a shroud that surrounds the fan on opposed sides but does not extend around the top or bottom of the fan. The fan assembly is enclosed by the projector housing cover so that the first and second shroud sections together with the projector housing cover completely enclose the fan.

A first shroud section includes a motor mount to which the fan is connected preferably through a press fit. This shroud section is removably attached to the projector housing cover by a fastener. A second shroud section is located on the opposite side of the fan and may either be integral with the projector housing cover or be removably attached to the projector housing cover by a fastener. The split shroud design allows the fan assembly to have a low profile and be limited in height to substantially no more than the height of the fan which in turn provides for a more compact projector housing. The split shroud substantially surrounds the fan on opposed sides to form the fan assembly which is mounted within the projector housing. The projector housing cover encloses the fan assembly and actually completes the enclosure of the fan at the top and bottom thus forming together with the split shroud a complete fan enclosure to provide sufficient air flow to cool the components of the image projector.

In another preferred embodiment the shroud is formed integral with a portion of the projector housing. In this embodiment a section of the housing is formed in one piece to include a split shroud configuration. The opposed shroud sections extend out and surround a portion of the fan but do not completely encircle the fan. The housing section includes a motor mount and support for the fan which, when installed, forms with the split shroud the fan assembly. The projector housing cover encloses the fan assembly and extends across the gap between the opposed shroud sections to fully enclose the fan.

The present invention saves space by eliminating the conventional fan housing and using a split shroud that is mounted into the housing cover or can be made integral with a portion of the housing.

Additional objects and advantages of this invention will be apparent from the following detailed description of preferred embodiments thereof which proceeds with reference to the accompanying drawings.

### BRIEF DESCRIPTION OF THE DRAWINGS

FIG. 1 is an isometric view of an image projector enclosure showing a lamp module removed from the projector enclosure to reveal a fan assembly.

FIG. 2 is a schematic front view of a standard fan assembly.

FIG. 3 is a schematic front view of a preferred embodiment of the fan assembly of the present invention.

FIG. 4 is an isometric view of the fan assembly shown in FIG. 3.

FIG. 5 is a simplified exploded view of the fan assembly of FIG. 3 and a bottom projector housing cover.

FIG. 6 is a simplified assembly view of the fan assembly of FIG. 5.

FIG. 7 is an isometric view of another embodiment of the fan assembly.

FIG. 8 is another isometric view of the fan assembly of FIG. 5.

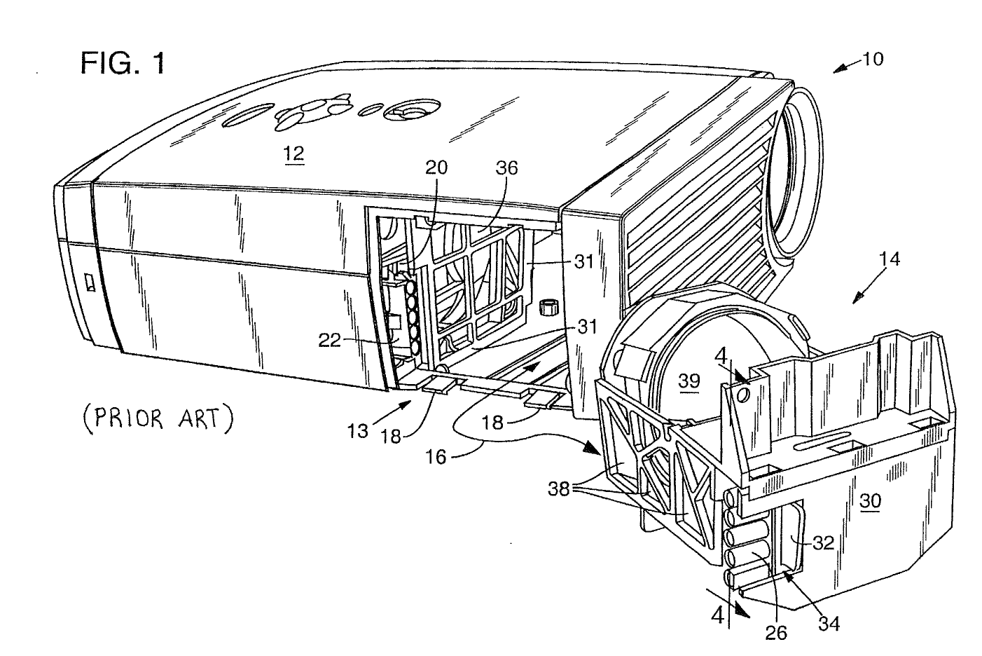

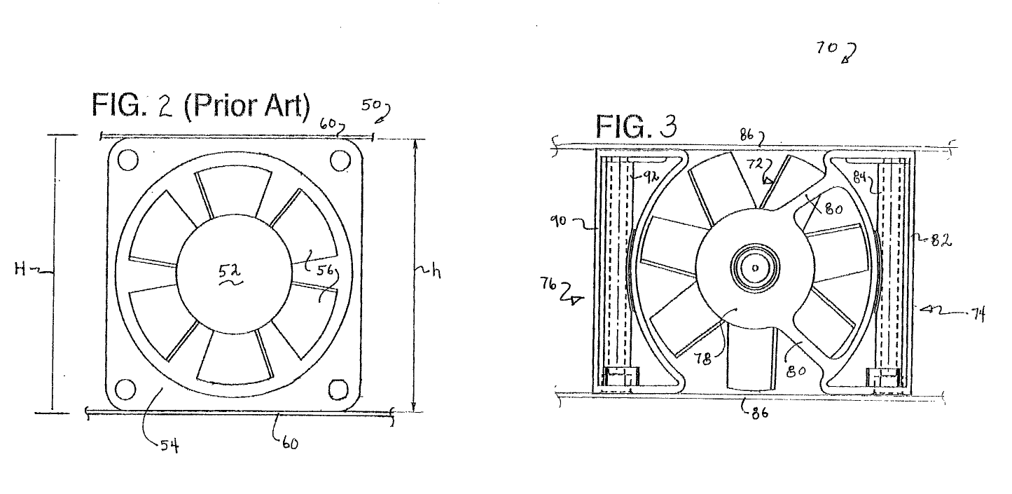

### DETAILED DESCRIPTION OF PREFERRED EMBODIMENT

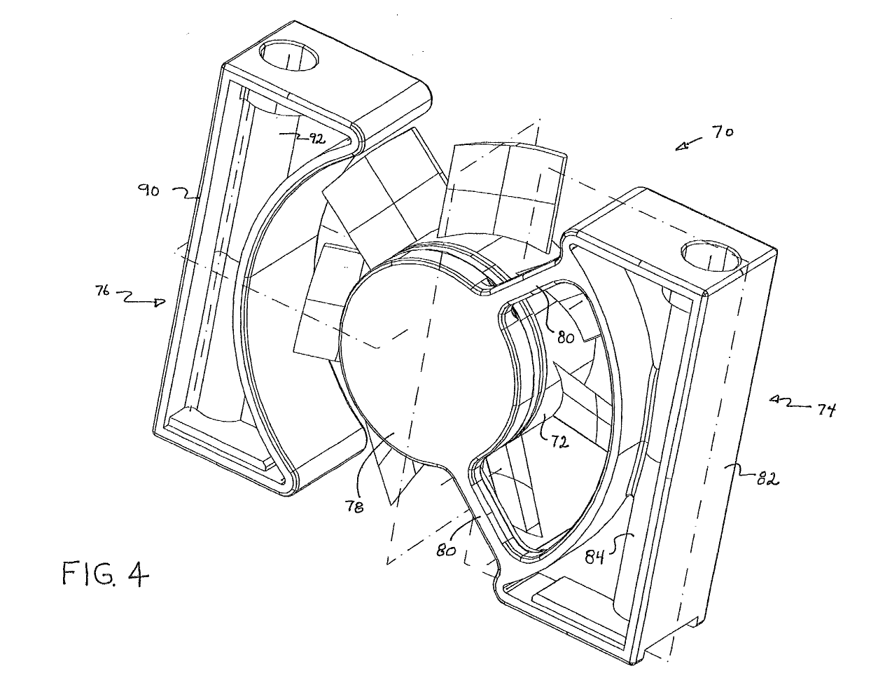

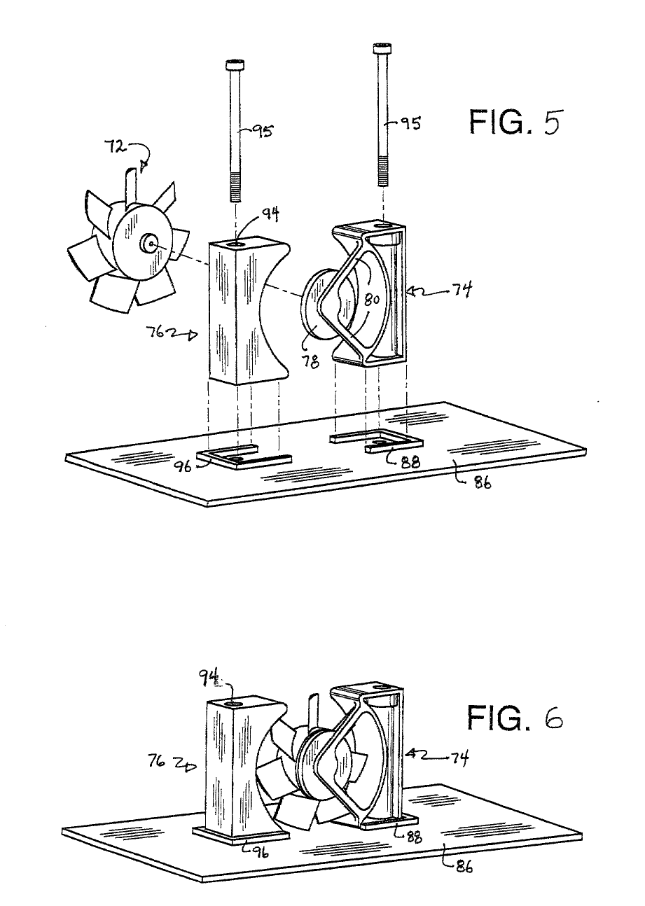

FIGS. 3-6 show a preferred embodiment of the fan assembly 70 of the present invention that includes a fan 72, a first shroud section 74, and a second shroud section 76. The fan 72 is supported by the first shroud section 74 that includes a fan motor mount 78 attached to the first shroud section 74 by struts 80. The fan 72 may be connected to the motor mount 78 in any manner most suitable but is preferably connected by a press fit. The first shroud section 74 includes a support bracket 82. A fastener tube 84 extends through the support bracket 82 to accommodate a fastener for securing the first shroud section 74 to the projector housing cover 86 (FIG. 5). The projector housing cover 86 forms the top and bottom of the product. As seen most clearly in FIGS. 5 and 6, the housing cover 86 may include an integral retainer rib 88 that locates and helps retain the first shroud section 74. The second shroud section 76 is similar to the first shroud section 74 except for the fan motor mount 78. The second shroud section 76 includes a support bracket 90 having a fastener tube 92 extending through the support bracket 76 as seen in FIG. 4. Alternatively, the second shroud section 74 may be a solid piece as seen in FIGS. 5 and 6 having a through opening 94 for a fastener 95. The first and second shroud sections 74 and 76 may be molded from any suitable plastic or cast from a magnesium aluminum alloy. The housing cover 86 may also include a second integral retainer rib 96 for the second shroud section 74.

As seen most clearly in FIGS. 3 and 6 when the fan assembly 70 is installed it nests within the projector housing cover 86 so that the projector housing cover 86 extends across the first and second shroud sections 74 and 76 and actually completes the enclosure of the fan 72. The projector housing cover 86 forms together with the first and second shroud sections 74 and 76 a complete enclosure to provide sufficient air flow to cool the components of the image projector.

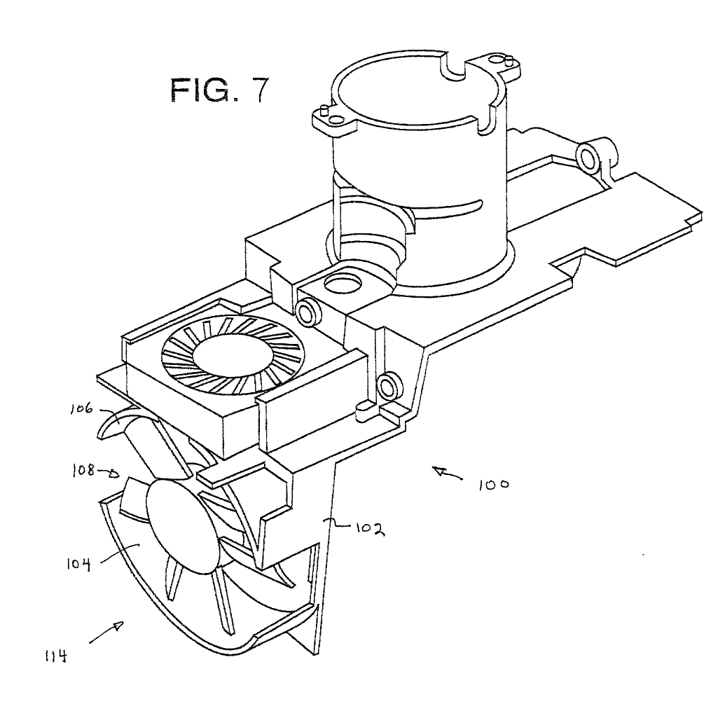

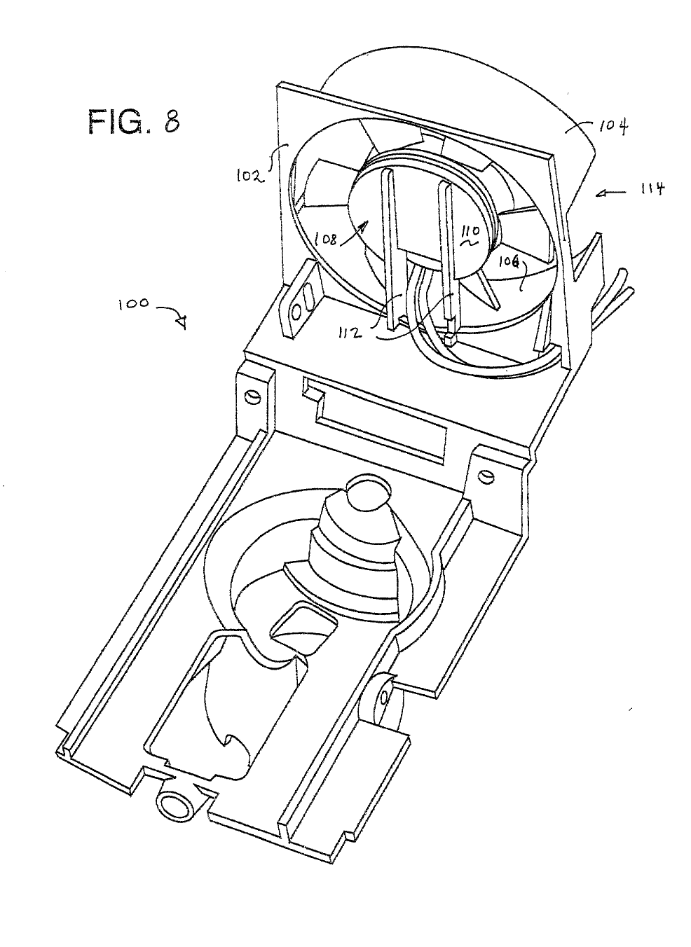

FIGS. 7 and 8 show another preferred embodiment of the invention wherein the split shroud is formed integral with a housing section. One example of a housing section with which the split shroud may be formed integral is an optical chassis 100 although it is understood that the split shroud may be formed integral with any other suitable portion that forms part of the housing. The optical chassis 100 includes a shroud base 102 from which shroud sections 104 and 106 extend to partially enclose a fan 108. A fan motor mount 110 is supported by struts 112 and the fan 108 is mounted to the motor mount 110 preferably by a press fit or any other suitable connection. The shroud sections 104 and 106 with the fan 108 form a fan assembly 114 that is low in profile similar to the embodiments of FIGS. 3-6. The optical chassis 100 is assembled into a projector housing (not shown). A projector housing cover (not shown) extends across the first and second shroud sections 104 and 106 to fully enclose the fan 108 in a manner similar to the embodiment seen in FIG. 3.

Thus, the present invention provides a low profile fan assembly in which the fan shroud is formed in a split configuration which provides a fan assembly having a reduced height allow the projector housing to be more compact and, thus, to have a reduced height.

It will be obvious to those having skill in the art that many changes may be made to the details of the above-described embodiment of this invention without departing from the underlying principles thereof. The scope of the present invention should, therefore, be determined only by the following claims.

1. A fan assembly for an image projector including a housing and a housing cover, the fan assembly comprising:
a fan having a height, and
a shroud that substantially surrounds the fan, the shroud having a height such that the height of the fan and the height of the shroud are substantially equal.

2. The fan assembly of claim 1, wherein the shroud comprises a first section and a separate second section, wherein the first section includes a fan motor mount for mounting the fan to the first section.

3. The fan assembly of claim 1, wherein the shroud comprises first and second opposed sections that partially surround the fan but do not fully enclose it.

4. The fan assembly of claim 3, wherein each of the first and second opposed sections include a through opening for a fastener for connecting the opposed sections to the housing cover.

5. The fan assembly of claim 1, in which the shroud is integral with the housing.

6. The fan assembly of claim 5, wherein the shroud comprises opposed sections that surround the fan but do not fully enclose it.
